(19) United States
(12) Patent Application Publication
(10) Pub. No.: US 2013/0001891 A1
(43) Pub. Date: Jan. 3, 2013

(54) SEALING ASSEMBLY

(75) Inventor: Benjamin R. Tower, Varna, IL (US)

(73) Assignee: Caterpillar Inc., Peoria, IL (US)

(21) Appl. No.: 13/172,079

(22) Filed: Jun. 29, 2011

(51) Int. Cl. F02F 11/00; B23P 11/00; F16J 15/02

(52) U.S. Cl. 277/591; 277/590; 29/428

(57) ABSTRACT

A two-piece assembly having both a plug component and a load component. The plug component includes a protrusion or bite edge that is capable of creating a metal-to-metal seal. The load component is rotated into position such that it provides an axial force on the plug component and increases the quality of the metal-to-metal seal. Rotational force from the load component is not transferred to the plug component because of a zero-moment interface. Thus, the present sealing assembly is capable of sealing at high pressures and avoid creating leak paths in the sealing land.

### TECHNICAL FIELD

The present disclosure relates generally to a high pressure seal assembly, and more particularly to a non-rotating high pressure seal assembly for use on high pressure fuel rails, junction blocks, pump heads or other high pressure components that require sealing of high pressure fluid.

### BACKGROUND

Engines, including diesel engines, gasoline engines, natural gas engines, and other engines known in the art, exhaust a complex mixture of combustion related constituents. The constituents may be gaseous and solid material, which include nitrous oxides (NOx) and particulate matter. Due to increased attention on the environment, exhaust emission standards have become more stringent and the amount of NOx and particulate matter emitted from an engine may be regulated depending on the type of engine, size of engine, and/or class of engine.

Engineers have come to realize that one way of achieving the stringent standards relating to NOx and particulate emissions is may be through increased fuel injection pressures. It is not unusual for modern common rail fuel systems to reach injection pressures in excess of 250 MPa (2500 Bar). Fuel system components, including common rails and seals must be able to safely withstand these increased pressures.

Common rails have traditionally been sealed using a rotational bite edge metal-to-metal seal. These seals are rotated into place where they create a seal. For example, U.S. Pat. No. 6,129,359 to Haas shows a seal having external threads with a knife or bite edge on the distal end. When this seal is rotated into position, a metal-to-metal seal can be created. However, in fuel systems with increased pressures, the risk of creating a leak path due to the rotation of the bite edge against the mating part is significantly higher.

The disclosed seal assembly is directed to overcoming one or more of the problems set forth above.

### SUMMARY OF THE DISCLOSURE

In one aspect, a seal including a plug component having a sealing surface and a load-receiving surface. Also included is a load component having a load surface configured to engage load receiving surface such that the load component applies an axial force to the plug component and minimizes rotational force applied to the plug component.

In another aspect, a fuel system for an internal combustion engine, including a fuel source. Also included is at least one fuel pump in fluid communication with the fuel source and configured to pressurize fuel. Also included is a common rail in fluid communication with the at least one fuel pump. The common rail also includes a seal having a plug component having a sealing surface and a load-receiving surface. The seal also includes a load component having a load surface configured to engage load receiving surface such that the load component applies an axial force to the plug component and minimizes rotational force applied to the plug component. The fuel system also includes at least one fuel injector in fluid communication with the common rail and configured to inject fuel into a cylinder of the internal combustion engine.

In yet another aspect, a method of sealing a span, including a step of providing a plug component having a sealing surface and a load-receiving surface. Also included is the step of positioning the plug component such that the sealing surface covers the span. The method also includes the step of providing a load component having a load surface configured to engage load-receiving surface. Also included is the step of applying a rotational force on the load component such that an axial force is applied on the plug component and rotational force applied to the plug component is minimized.

### BRIEF DESCRIPTION OF THE DRAWINGS

FIG. 1 is a diagrammatic schematic of a fuel system having a common rail and the disclosed sealing assembly;

FIG. 2 is a detailed cross section of a portion of a common rail and the disclosed sealing assembly;

FIG. 3 is a perspective view of a first embodiment of the disclosed sealing assembly; and

FIG. 4 is cross section of a second embodiment of the disclosed sealing assembly.

### DETAILED DESCRIPTION

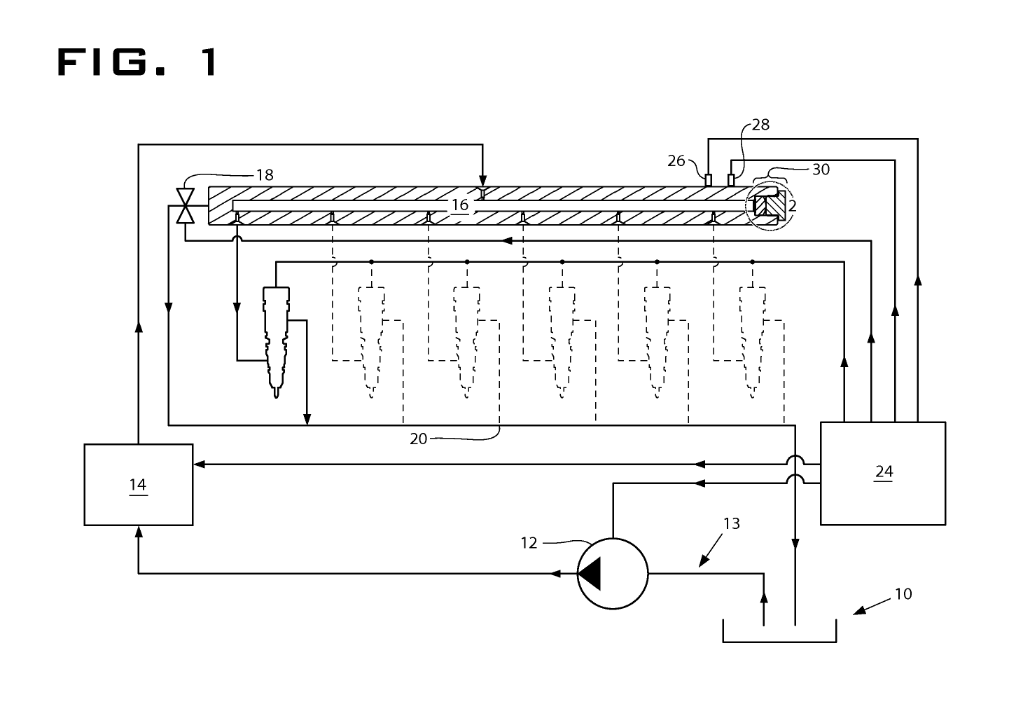

Referring to FIG. 1, a fuel system utilizing a common rail fuel injector 22 is shown. A reservoir 10 contains fuel at an ambient pressure. A transfer pump 12 draws low-pressure fuel through fuel supply line 13 and provides it to high-pressure pump 14. High-pressure pump 14 then pressurizes the fuel to desired fuel injection pressure levels and delivers the fuel to the fuel rail 16. Fuel rail 16 may include at least one sealing assembly 30. The pressure in fuel rail 16 is controlled in part by safety valve 18, which spills fuel to the fuel return line 20 if the pressure in the fuel rail 16 is above a desired pressure. The fuel return line 20 returns fuel to reservoir 10.

Fuel injector 22 draws fuel from fuel rail 16 and injects it into a combustion cylinder of the engine (not shown). Fuel not injected by fuel injector 22 is spilled to fuel return line 20. Electronic Control Module (ECM) 24 provides general control for the system. ECM 24 receives various input signals, such as from pressure sensor 26 and a temperature sensor 28 connected to fuel rail 16, to determine operational conditions. ECM 24 then sends out various control signals to various components including the transfer pump 12, high-pressure pump 14, and fuel injector 22.

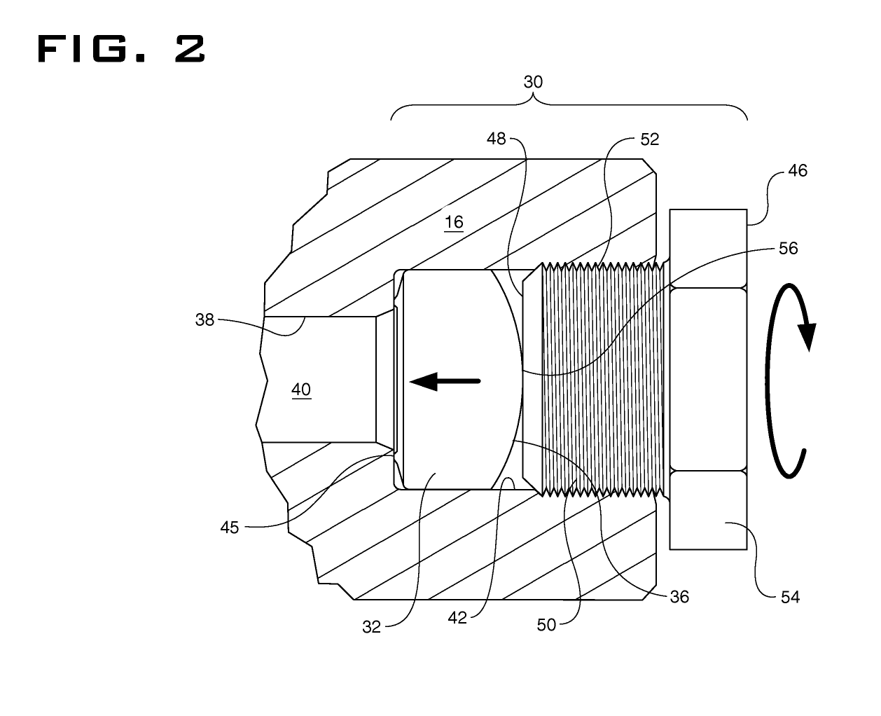

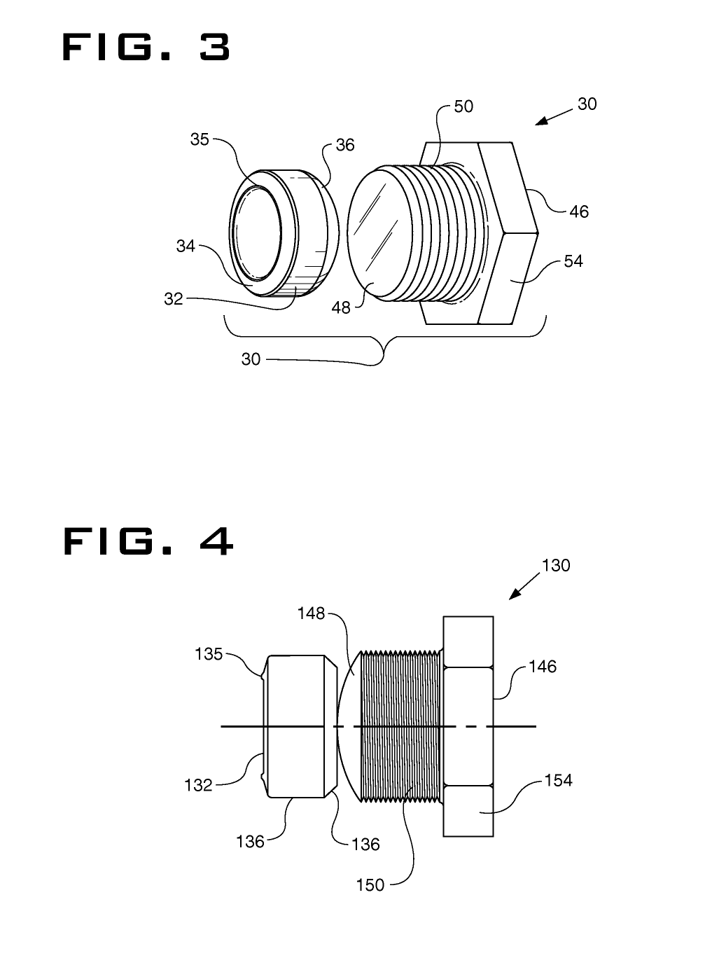

A first embodiment of the disclosed sealing assembly 30 is shown in FIGS. 2 and 3. FIG. 2 shows a detailed cross section of the disclosed sealing assembly 30 and a portion of a fuel rail 16, and FIG. 3 shows a perspective view the sealing assembly 30. Sealing assembly 30 includes a plug component 32 having sealing surface 34 and a load-receiving surface 36. Sealing surface 34 may further include one or more protrusions 35 that improve the efficacy of the sealing surface. In FIG. 3, the protrusion 35 can be seen to be in the shape of a ring that is known as a “knife edge” or a “bite edge”. Fuel rail 16 may define a bore 38 having an interior portion 40 that is configured to accumulate pressurized fuel. Bore 38 may also include a widened portion 42 toward an end of the fuel rail. At the interface where the interior portion 40 and the widened portion 42 meet, fuel rail 16 defines a shoulder 44. Plug component 32 is inserted into the widened portion 42 such that the sealing surface 34 engages shoulder 44. When the sealing surface 34 engages shoulder 44, fluid communication between the interior portion 40 and the widened portion 42 is prevented. More specifically, when protrusion 35 engages the shoulder a seal 45 is formed.

Sealing assembly 30 also includes a load component 46. Load component 46 includes at least one load surface 48. Load component 46 may further include exterior threads 50. Exterior threads 50 may be configured to engage mating threads 52 that are located in the widened portion 42 of bore 38. As shown in FIG. 2, load component may further include tool engaging surfaces 54. Tool engaging surfaces 54 may be gripped by a wrench (not shown) or similar tool used to rotate load component 46. As load component 46 is rotated, exterior threads 50 and mating threads 52 are engaged such that load component 46 moves axially into widened portion 42. The load component 46 thus applies an axial force to the plug component 32. More specifically, the load surface 48 of load component 46 engages the load-receiving surface 36 of plug component 32, and thereby applies an axial force. The greater the axial force applied to the load receiving surface of plug component 32, the greater the seal caused by the engagement of protrusion 35 and shoulder 44.

Although the axial force applied to plug component 32 is achieved by rotating load component 46 into place, rotational force applied to the plug component 32 is minimized because of a zero-moment interface 56 between the load surface 48 and the load-receiving surface 36. For example in the embodiment shown in FIGS. 2-3, the load-receiving surface 36 includes at least a portion that is at least partially concave or spherical in shape, while the load surface 48 is substantially flat. Thus, when the load component 46 is rotated into place, a zero-moment interface 56 between the load surface 48 and the load-receiving surface 36 is formed. At the zero-moment interface 56 surface area contact between the load surface 48 and the load-receiving surface 36 is minimized. Therefore, friction at the zero-moment interface is also minimized. Because of the reduced friction at the zero-moment interface 56, axial force from the load component 46 is transferred to the plug component 32, while rotational force is minimized.

FIG. 4 depicts a second embodiment of the disclosed sealing assembly 130. In this second embodiment, sealing assembly 130 includes a plug component 132 having a sealing surface 134 and a load-receiving surface 136. Sealing surface 134 may further include one or more protrusions 135 that improve the efficacy of the sealing surface 134. Sealing assembly 130 also includes a load component 146. Load component 146 includes at least one load surface 148. Load component 146 may further include exterior threads 150. Load component 146 may further include tool engaging surfaces 154. Tool engaging surfaces 154 may be gripped by a wrench (not shown) or similar tool used to rotate load component 146.

In operation, the second embodiment of the disclosed sealing assembly 130 operates similarly to that of the first embodiment. The load component 146 is rotated into position, wherein the exterior threads 150 engage with mating threads (not shown) apply an axial force on the plug component 132. Similar to the first embodiment, although the axial force applied to plug component 132 is achieved by rotating load component 146 into place, rotational force applied to the plug component 132 is minimized because of a zero-moment interface 156. Herein lies the key difference between the first and second embodiments. In the first embodiment, the zero-moment interface 56 is achieved through a substantially flat load surface 48 and an at least partially concave or spherical load-receiving surface 36. In the second embodiment, the opposite is true. The zero-moment interface 156 is formed by a load surface 148 that includes at least a portion that is concave or spherical and a load-receiving surface 136 that is substantially flat. Similar to the first embodiment, at the zero-moment interface 156 of the second embodiment, surface area contact between the load surface 148 and the load-receiving surface 136 is minimized. Therefore, friction at the zero-moment interface 156 is also minimized. Because of the reduced friction at the zero-moment interface 156, axial force from the load component 146 is transferred to the plug component 132, while rotational force is minimized.

Those skilled in the art will readily recognize that other embodiments may exist that does not depart from the scope or spirit of the present disclosure. The key is that the surface area at the zero-moment interface is minimized. This could be done with either or both of the load receiving surface and the load surface being concave, spherical, or even conical.

### INDUSTRIAL APPLICABILITY

Modern common rail fuel systems are operating at ever increasing pressures. As these pressures increase, the quality of the metal-to-metal seals of the fuel rails must also increase. Traditionally, ball plugs or rotating bite edge seals have been used. Ball plugs provide good seals up to certain minimum fuel pressures (e.g., >190 MPa). Ball plugs often cannot exceed these higher pressures because they do not create a true metal-to-metal seal. Seals having a rotating bite edge generally can seal at higher pressures because the bite edge creates a true metal-to-metal seal. However, rotating bite edge plugs may cause other problems. Rotation of a plug component into sealing position may compromise the integrity of the seal because it can create leak paths in the sealing land. At increased pressures, these leak paths become evident.

The sealing assembly of the present disclosure is a two-piece assembly having both a plug component and a load component. The plug component includes a protrusion or bite edge that is capable of creating a metal-to-metal seal. The load component is configured to be rotated into position such that it provides an axial force on the plug component and increases the quality of the metal-to-metal seal. Rotational force from the load component is not transferred to the plug component because of a zero-moment interface. The zero-moment interface between the plug component and load component is formed because the surface area between the two components is minimized. By minimizing the surface area, friction is minimized. Minimizing friction also minimizes rotationally transferred forces. Thus, the present sealing assembly simultaneously seals at high pressures and avoids creating leak paths in the sealing land.

Those skilled in the art will recognize that the disclosed sealing assembly can be used to seal high pressure fuel rails. In addition to high pressure fuel rails, the disclosed assembly can also be used to seal junction blocks, pump heads or any other high pressure component that requires sealing of a high pressure fluid.

The above description is intended for illustrative purposes only and is not intended to limit the scope of the present disclosure in any way. Thus, those skilled in the art will appreciate the various modifications and uses for the illustrated embodiments without departing from the spirit and scope of the disclosure, which is defined in the terms of the claims set forth below.

What is claimed is:

1. A sealing assembly comprising:
A plug component having a sealing surface and a load-receiving surface;
A load component having a load surface configured to engage load-receiving surface such that a zero-moment interface is formed, wherein the load component applies an axial force to the plug component and minimizes rotational force applied to the plug component.

2. The sealing assembly of claim 1, wherein the sealing surface includes a sealing edge.

3. The sealing assembly of claim 2, wherein a portion of the load-receiving surface is partially spherically shaped.

4. The sealing assembly of claim 3, wherein the load surface is substantially flat

5. The sealing assembly of claim 3, wherein a portion of the load surface is spherically shaped.

6. The sealing assembly of claim 2, wherein the load receiving surface is substantially flat

7. The sealing assembly of claim 6, wherein a portion of the load surface is spherically shaped.

8. The sealing assembly of claim 1, wherein the load component further includes a threaded portion, and wherein the plug component further includes a threaded portion.

9. A fuel system for an internal combustion engine, comprising:
A fuel source; and
At least one fuel system component in fluid communication with the fuel source and further comprising a sealing assembly comprising:
A plug component having a sealing surface and a load-receiving surface;
A load component having a load surface configured to engage load receiving surface such that a zero-moment interface is formed, wherein the load component applies an axial force to the plug component and minimizes rotational force applied to the plug component.

10. The fuel system of claim 9, wherein the sealing surface includes a sealing edge.

11. The fuel system of claim 10, wherein a portion of the load-receiving surface is partially spherically shaped.

12. The fuel system of claim 11, wherein the load surface is substantially flat

13. The fuel system of claim 11, wherein a portion of the load surface is spherically shaped.

14. The fuel system of claim 10, wherein the load receiving surface is substantially flat

15. The fuel system of claim 14, wherein a portion of the load surface is spherically shaped.

16. The fuel system of claim 9, wherein the load component further includes a threaded portion, and wherein the plug component further includes a threaded portion.

17. The fuel system of claim 9, wherein the fuel system component is selected from the group consisting of fuel pumps, fuel rails, and junction blocks.

18. A method of sealing a span, comprising the following steps:
Providing a plug component having a sealing surface and a load-receiving surface;
Positioning the plug component such that the sealing surface covers the span;
Providing a load component having a load surface configured to engage load-receiving surface such that a zero-moment interface is formed;
Applying a rotational force on the load component such that an axial force is applied on the plug component and rotational force applied to the plug component is minimized.
